(19) United States
(12) Patent Application Publication
(10) Pub. No.: US 2004/0076754 A1
(43) Pub. Date: Apr. 22, 2004

(54) Method and arrangement in manufacturing of printing paper

(76) Inventors: Pasi Rajala, Turku (FI); Pertti Heikkila, Raisio (FI)

Correspondence Address: STIENNON & STIENNON, 612 W. MAIN ST., SUITE 201, P.O. BOX 1667, MADISON, WI, 53701-1667, US

(21) Appl. No.: 10/468,309

(22) PCT Filed: Mar. 6, 2002
(86) PCT No.: PCT/FI02/00172

(30) Foreign Application Priority Data
Mar. 9, 2001 (FI) 20010479

(51) Int. Cl. B05D 3/12; B05C 11/00; B05C 1/00

(52) U.S. Cl. 427/355; 118/261; 118/223; 118/58; 118/65

(57) ABSTRACT

The invention relates to a method and an arrangement in the manufacture of coated printing paper when coating the paper web at least on one side. For drying the paper after the coating station, a dryer is used by means of which the web is dried with hot air or superheated steam or infrared radiation, or a combination of these is used. The said dryer is placed immediately after the coating station. The drying of the paper is continued in the said dryer at least until the coating in the dryer area reaches its solidification point.

The object of the invention is a method and an arrangement in the manufacture of coated printing paper, when coating the paper web at least on one side. For drying the paper after the coating station, one or several dryers placed essentially close to each other are used,

In the manufacture of coated printing paper, a coating station is generally used, by means of which a paste-like substance, usually having a dry matter content of 50-70%, is applied to the surface of the paper. As the paste-like substance has such a high water content, water is absorbed from the paste-like substance into the paper, and at the same time the moisture content of the paper rises, usually To a level of 10-20%. For this reason, the paper and thus also the paste-like substance applied to its surface have to be dewatered, that is, the paper has to be dried. In such cases, an infrared dryer, an air-borne dryer or a cylinder dryer or combinations of these are most generally used.

The surface of the coating layer made at the coating station can be made fairly smooth by means of scraping, a method using a blade for scraping off excess paste-like substance and at the same time for smoothing the surface. After the coating station the paper web generally has a certain distance of so-called free draw, after which a conventional arrangement comprises first an infrared dryer and afterwards one or several air dryers fitted in succession. At a subsequent point on the paper web, there is a second coating station with corresponding drying devices, this second apparatus being used to coat the other side of the paper in a similar way. Sometimes the coating is carried out twice, which means that apparatus is required accordingly. Sometimes both sides of the paper are coated at the same time, e.g. by means of a so-called film transfer coater. The behaviour of the paste-like substance on the surface of the paper as well as the phenomena occurring in the paper itself after the coating station should be considered more closely, as the impact of these factors on the paper quality is very significant. On account of the said dryers, the paper fibres shrink the water contained in the paper flows in a capillary manner, some of the water contained in the paper evaporates and condenses, and a flow of humid air takes place. The ingredients of the paste-like substance also move in the wet coating layer. The roughness of the paper can always vary to some extent at different points, due to which the amount of paste-like substance applied to the surface of the paper is greater at some points and less at some other points. Therefore, the paste-like substance solidifies at certain points faster than at others. This makes the coating layer different at different points, which causes quality problems at the paper printing stage, of which problems print mottling is a rather visible phenomenon and is experienced as disadvantageous. This is caused by the fact that printing ink is absorbed unevenly into the surface being printed. One of the basic reasons for this is the non-homogeneous structure of the paper and at the same of its coating substance, resulting from the rather slow and non-simultaneous drying in the direction of the surface. For the same reason, the smoothness and the gloss of the paper can vary at different points. Dusting can also occur to a greater extent than is usual. There are various established standard testing arrangements for analysing the behaviour of coated printing paper in the press and for examining otherwise the print quality obtained.

The aim of the invention is to present a method and an arrangement to be used in drying paper after the coating station, for preventing print mottling from occurring in the printing paper, for improving the smoothness and the gloss of the paper and also for reducing dusting. Briefly, the invention concerns improving the quality of the printing paper.

The aim of the invention is achieved in the maimer of the method presented in the independent claim 1 and of the arrangement presented in the independent claim 9 and in the manner presented in the other claims. The invention relates to a method in the manufacture of coated printing paper, when coating the paper web at least on one side, whereby a dryer is used when drying the paper after the coating station, in which dr hot air or superheated steam is blown or infrared radiation is directed towards the web. The dryer can be a combination of these. If the said dryer is placed immediately after the coating station and if the drying of the paper is continued in the said dryer at least until the coating reaches its solidification point in the dryer area, the solidification of the coating can be achieved very rapidly by means of an efficient dryer and in such a way that a uniform binder content is obtained in the coating surface. In such a case, print mottling, which is experienced as disadvantageous, does not usually occur at all in the use of the coated printing paper.

If one dryer or several dryer units placed close to each other are chosen as the dryer, the drying takes place as a maximally uniform and fast process after the coating station.

If the forward end of the dryer is placed at a distance of less than 4 meters from the coating station, but preferably at a distance of less than 2 meters from the coating station, the drying begins in practical applications as close immediately after the coating station as possible. During such a short free draw, there is hardly any time for the coating to change, even if there is no heat supply to the paper web during this interval.

If the dryer is dimensioned to be so efficient that the dry matter content of the coating after the dryer is at least 73%, preferably over 85%, the paper with its coating dries efficiently and rapidly in the dryer area.

If the dryer is dimensioned so that the travel time of the paper web in the area of the said dryer is less than 500 ms, preferably less than 300 ms, the surface of the coating dries very fast, and there is no time for such disadvantageous phenomena to take place in the coating as in the process of slow drying.

If at least one turning roll or the like is placed between the dryer units that are located close to each other, in case the dryers are not parallel in relation to the paper web direction, the method and the arrangement relating to the invention can be used not only in new machines, but also in rebuilds of old machines. As regards the use of space, it is often advantageous to divide the dryer into two dryer units that are not parallel to each other.

If the paper is coated with one or two coating layers either on one side or on two sides, the most appropriate coating method and coating amount can be selected for the intended use of the paper.

If the paper is dried further after the dryer with a cylinder group, or if the travel of the web is assisted by means of a drawing roll group and reeled up at the end with a roller, it is possible to manufacture printing paper of good quality and with the desired properties. At a subsequent stage, finishing treatments can naturally still be applied before the paper is delivered to the print house.

The invention is described in greater detail in the following, with reference to the appended drawing, in which

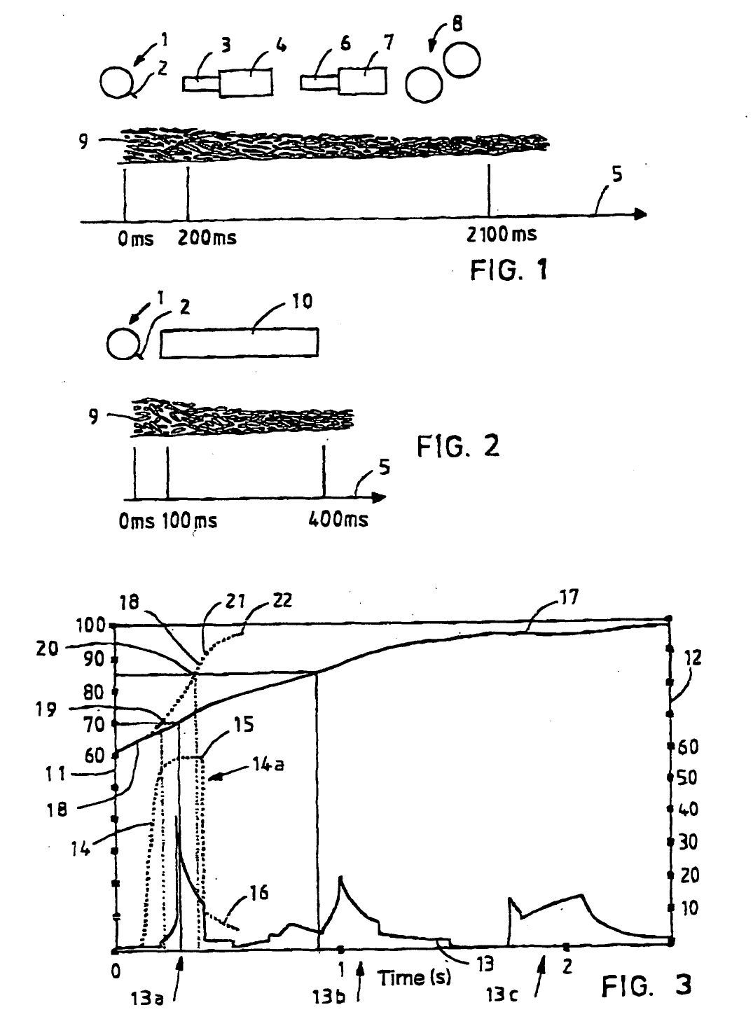

FIG. 1 shows diagrammatically a drying arrangement according to the known prior art in the manufacture of printing paper after the coating station,

FIG. 2 shows diagrammatically the drying of paper relating to the invention in the manufacture of printing paper after the coating station,

FIG. 3 shows diagrammatically, as a function of time, curves describing the increase in the dry matter content of the paste-like substance and also curves describing the evaporation rate on the coating side, both according to known prior art and according to the invention,

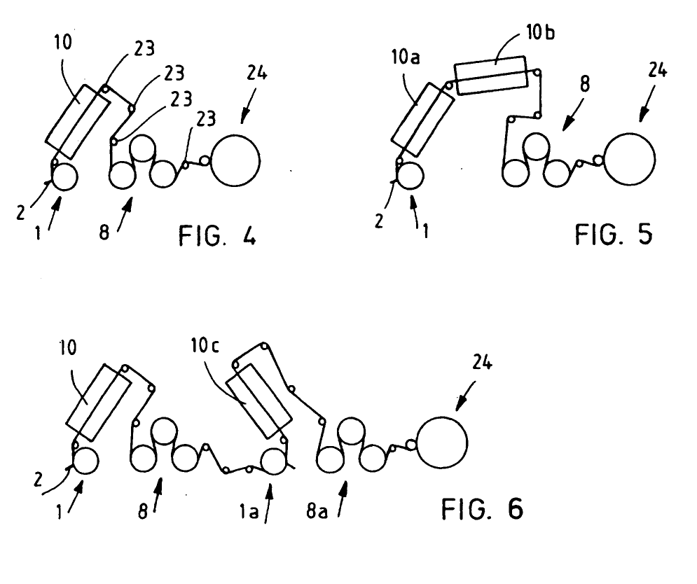

FIG. 4 shows diagrammatically a suitable apparatus for the arrangement relating to FIG. 2,

FIG. 5 shows diagrammatically an arrangement relating to FIG. 4, but using two dryers placed close to each other,

FIG. 6 shows diagrammatically two successive coating stations relating to FIG. 4 with their dryers for two-sided coating,

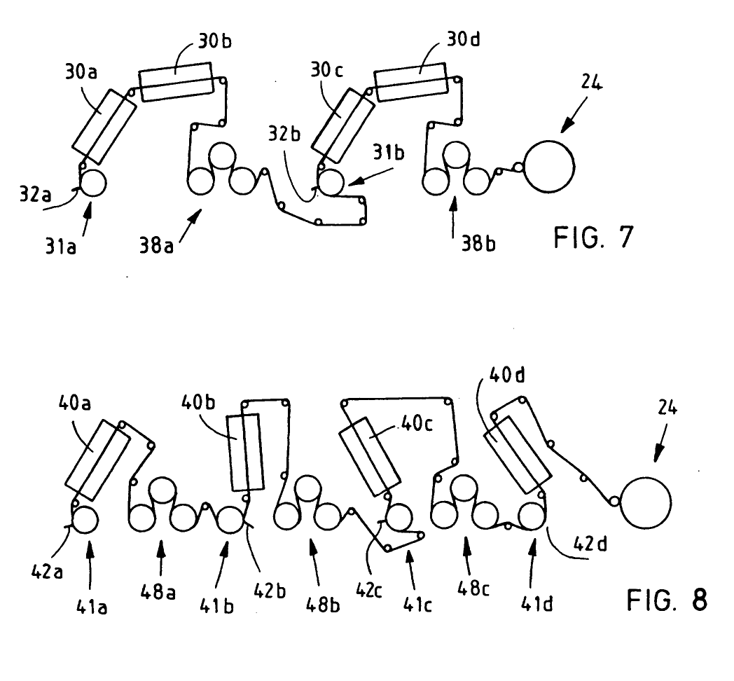

FIG. 7 shows diagrammatically an arrangement relating to FIG. 5 when coating the same side of the paper two times successively and

FIG. 8 first shows diagrammatically an arrangement relating to FIG. 6, but where the paper is coated and dried twice on both sides at further coating stations.

In FIG. 1 of the drawing, the reference number 1 indicates the coating station, at which paste-like substance is applied on die surface of the printing paper being manufactured and at which the excess paste-like substance is removed from the surface of the paper by means of a doctor blade 2, and at the same time a layer of paste-like substance with an even surface is obtained on the surface of the paper. After the coating station 1, the paper passes into a dryer, which usually comprises an infrared dryer 3 and an air dryer 4. The distance between the doctor blade 2 and the infrared dryer is usually a few meters, generally about two meters or even more. FIG. 1 also shows a time axis 5 representing approximately the time required far the paper web to travel in the devices and between the devices at the normal travelling speeds of the paper web. The speed of a paper web is usually at least 1000 m/min, and in fairly new paper machines it may even be clearly higher. In devices complying with the known prior art, the travel of the paper web from the doctor blade 2 to the infrared dryer takes about 200 ms. In such paper machines, a short free draw has generally been used after the air dryer 4 and before the second infrared dryer 6 and the second air dryer 7. The next stage of the paper web is the cylinder group 8, after which there are usually similar arrangements for treating the other side of the printing paper. The coating can also be carried out twice successively on both sides if it is desired to achieve certain properties for the printing paper being manufactured.

The lower part of FIG. 1 shows the paste-like substance 9 greatly magnified on the surface of the paper at the stages shown in the upper part of FIG. 1. At the coating station 1, the paste-like substance 9 usually has at the application stage a dry matter content of 50-70%. Due to the application of a paste-like substance 9 as moist as this, the moisture content of the paper usually rises to a level of 10-20%. In order to later obtain a paper moisture content of 3-6%, water has to be removed from the paper, that is, the paper has to be dried. During the time interval 0-200 ms, there is a so-called free draw, and hardly any changes occur in the paste-like substance 9, since it is not affected by any drying device in that situation. In the area of the med dryer 3, water is removed from the paste-like substance 9 due to the effect of the heat radiation caused by the infrared dryer 3, and the temperature of the paper rises at the same time. The water removal continues in the area of the air dryer 4. Due to the effect of the air dryer 4, the paper has heated up, and water removal also takes place to some extent in the area after the air dryer 4. In the area of the second infrared dryer 6 and the second air dryer 7, water is again removed rather efficiently. The printing paper has to be sufficiently dry, that is, the paper has to withstand contact with the first cylinder or roll of the cylinder group 8. On the cylinder group 8, the drying of the paper continues.

After the doctor blade 2 of the coating station 1, the drying of the paste-like moist substance 9 and of the base paper determines the final structure of the coating layer, and thus at the same time to a great extent the paper technical and printing properties of the finished product. Efficient heating of the paper web accelerates the solidification of the coating, and this has been observed to have a good effect on the quality of the finished printing paper. The initial drying is generally performed with an infrared dryer, which has the effect that the water in the paste-like substance 9 flows towards the base paper. Water soluble binders, such as starch and PVA (polyvinylalcohol) move relatively freely with the flow before solidification of the paste-like substance 9. The solidification of the paste-like substance 9 on the surface of the paper can particularly be considered as a critical stage in the drying, as its dry matter content at that stage is already about 73-85%. The pigment particles of the paste-like substance 9 come into contact with each other, and a structural mesh begins to form. The pore structure of the coating is formed expressly at the solidification stage. Water absorption into the base paper slows down considerably and the flow turns clearly towards the surface of the coating. Any soluble binders, such as starch and PVA, are typically prone to migration at this stage. In the final drying, the solidified coating is dried to the desired final dry matter content. Water absorption into the base paper stops and water passes through the coating onto the surface to be evaporated. The drying methods used after the solidification stage have been observed to have hardly any impact on the quality of the coating.

In the solution shown in FIG. 2 and relating to the invention, the free draw after the doctor blade 2 of the coating station 1 is rather short, preferably as short as it is technically possible to fit. A distance of about two meters is recommended. The forward end of the dryer 10, which is typically an air dryer, but which can also include a dryer section generating eared radiation, is placed immediately at the end of the free draw. The dryer should be dimensioned so as to be rather powerful. The temperature of the air to be blown should be over 350° C. and the blow rate should also be over 40 m/s, In such a case the water phase of the coating would flow in the same direction during the entire drying process. At a sufficiently high evaporation rate, it is possible to have the “evaporation front” inside the coating already at the initial stage of drying. The surface of the coating thus has a uniform binder content and “collapsing” and stage of the coating are minimised. At a sufficiently high evaporation rate the viscous force does not take hold of the fines and binders of the pigment, and thus their migration is prevented. With this drying method, the coating becomes bulky and opaque, while at the same time a sufficient level of porosity and gloss can be obtained, even though increasing the porosity of the coating may impair the gloss. If needed, the binder migration can be directed in the desired direction by adjusting the evaporation rate. The lower part of FIG. 2 shows diagrammatically that the free draw after the coating station is about half of that which has been used in solutions according to the known prior art and that the dryer is so powerful that the paper web is typically in the dryer 10 only for less than 300 ms, whereas in the solutions according to the known prior art, e.g. in the solutions relating to FIG. 1, the paper web is in the area of the dryers 3,4 in the area of the free intermediate draw and in the area of the dryers 6 and 7 for a time lapse in the order of 1000 ms. The normally used cylinder group 8 is not shown in FIG. 2, although it is most often used.

The horizontal axis of FIG. 3 shows tie in seconds within the range of 0-2.5, the zero point being at the doctor blade 2 of the coating station 1. The left-hand vertical axis 11 shows the dry matter content of the coating as a percentage within the range of 0-100%. The right-hand vertical axis 12 shows the evaporation rate of water from the printing paper coated at the coating station on the coating side, the measurement unit being kg/m²/h. The curve 13 shows the evaporation rate in the solution relating to FIG. 1, and the current values at any point of time can be read from the axis 12. The curve 13 has a first peak area 13a, which represents the evaporation rate due to the effect of the dryers 3 and 4, a second peak area 13b, which represents the evaporation rate in the area of the dryers 6 and 7 and a peak area 13c, which represents the evaporation rate in the cylinder group 8. In the intermediate areas between the said peak areas, the evaporation rate is low. The curve 14, shown as a broken line, represents the evaporation rate in an arrangement relating to the invention. As described above, the forward end of the dryer 10 is relatively close to the coating station 1, so that the initial part of the curve 14 on the horizontal axis begins to rise clearly before the curve of the peak area 13a of the curve 13 begins to rise. After the end of the dryer 10, which end has been designated by the reference number 15, the evaporation rate decreases to a rather low level, even though the evaporation still continues around point 16, because the paper is warm. In this diagram the peak areas 13a and 13b of the evaporation rate in the arrangement according to the known prior art have been replaced by the peak area 14a of the curve 14 of a solution relating to the invention. The amount of evaporated water is approximately the same in both solutions.

The curve 17 represents the dry matter content of the paste-like substance 9 of a solution according to the known prior art as a function of time with the help of the measurement units (%) of the axis 11. At the doctor blade 2, the dry matter content is about 60%, and after the first drying combination 3+4, only about 75%. The dry matter content does not reach the level of approximately 85% until the area of the dryer 6 and it continues to rise, due to the effect of the dryer 7, to a level of approximately 90%. The cylinder group 8 does not significantly raise the dry matter content at the peak area 13c. The curve 18 shows the rise in the dry matter content occurring by means of the arrangement relating to the invention. The starting situation is of course the same in FIGS. 1 and 2 as regards dry matter content. At the point designated by the reference number 18, where the dryer 10 begins to have an effect, the curve shown as a broken line begins to rise clearly faster than the curve 17. In FIG. 3, the reference number 19 indicates the point at which the dry matter content has increased to a level of approximately 70% due to the effect of the arrangement relating to the invention, and at point 20 to a level of about 85%. The coresponding values for the curve 17 at corresponding points on the time axis are about 67% and 72%. The curve 18 continues to rise steeply throughout the area of the dryer 10 and still rises after the dryer 10, that is, after the point 21, although less steeply. In the free draw after the dryer 9, the dry matter content rises to a level of about 97% at point 22.

FIG. 4 shows one-side coating of the printing paper and drying according to the invention by means of the coating station 1, the dryer 10 and the cylinder group 8. The turning rolls 23 are used for guiding the paper web. At the end, the paper is reeled up with a roller 24.

FIG. 5 shows an arrangement quite similar to that shown in FIG. 4. The dryer 10 is formed of two parts, 10a and 10b, which are very close to each other. Between the dryers 10a and 10b, there may be a turning roll 23 and expressly on the side of die paper web that has no fresh coating. Such two-part dryer solutions may be necessary, for example, due to the lack of space, when for instance an old coating machine is being rebuilt in a location where there is limited space. The end of the web is similar to that in the arrangement shown in FIG. 4.

In the arrangement relating to FIG. 6, both sides of the paper may be coated in the manner relating to the invention. The arrangement is at first similar to the arrangement shown in FIG. 4, but after the turning rolls 23 located after the cylinder group 8, there is a second coating station 1a, after which are placed the turning roll 23, the dryer 10c, very close to the coating station 1a, turning rolls 23, a second cylinder group 8a and at the end the roller 24.

In the arrangement relating to FIG. 7, the paper is coated twice successively on the same side and two-part dryers are used for drying. First the coating station 31a, provided with the doctor blade 32a, applies the paste-like substance to the surface of the paper. The two-part dryer 30a, 30b dries the paper and the drying continues in the cylinder group 38a. Several turning rolls 23 are needed for guiding the paper web. By means of the doctor blade 32b, the coating station 31b applies a paste-like substance, which usually has a different composition than the paste-like substance applied at the first coating stage. The two-part dryer 30c, 30d dries the paper in a sufficient manner to allow for the coating to solidify and to dry sufficiently for the turning rolls 23. Final drying is carried out with the cylinder group 38b before the roller 24.

FIG. 8 shows an arrangement in which, using one-part dryers, the paper is coated first on the fist side at the coating station 41a using the doctor blade 42a. Drying is carried out according to the invention with the dryer 40a and the cylinder group 48a. The coating of the second side of the paper is carried out at the coating station 41b with the doctor blade 42b and the drying with the dryer 40b and further with the cylinder group 48b. The second coating of the first side of the paper is carried out at the coating station 41c and the further treatment with the dryer 40c and the cylinder group 48c. The second coating of the second side of the paper is carried out at the coating station 41d with the doctor blade 42d. Drying is carried out with the dryer 40d. At the end, the paper is reeled up with the roller 24. For the sake of clarity, the turning rolls 23 shown in FIG. 4 have not been given reference numbers at all in FIGS. 5-8. If necessary, it would also have been possible to use here a cylinder group for further drying before the roller 24 or before the drawing roll group for controlling the runnability of the web.

As stated, the difference between FIGS. 4 and 5 lies particularly in the structure of the dryer. If two dryer sections are made, the distance between them should be made as short as possible, so that the drying effect is not weakened due to the short gap. It is also possible to make the arrangement of FIG. 6 in a manner relating to the invention so that one of the dryers 10 or 10c of integral construction is replaced by a two-part dryer unit, and correspondingly in the arrangement relating to FIG. 8, one, some or all of the dryers 40a, 40b, 40c and 40d of integral construction can be replaced by two-part dryer units.

The coating of the paper may be carried out either in contact with the coating device or without contact with the coating device.

The invention is not limited to the embodiment presented above, but several variants thereof are conceivable within the scope of the claims below.

1. A method in the manufacture of coated printing paper based on doctor blade coating technique, when coating the paper web at least on one side, whereby a dryer is used for drying the paper after the coating station, by means of which dryer the web is dried with hot air or superheated steam or infrared radiation, or a combination of these is used, characterised in that the said dryer is placed immediately after the coating station and that the drying of the paper is continued in the said dryer at least until the coating in the dryer area reaches its solidification point and the dry matter content of the coating after the dryer is at least 73%.

2. A method as claimed in claim 1, characterised in that the dryer selected is either one single dryer or several dryer units placed close to each other.

3. A method as claimed in claim 2, characterised in that the forward end of the dryer is placed at a distance of less than 4 meters from the coating station, but preferably at a distance of less than 2 meters from the coating station.

4. A method as claimed in any of the claims above, characterised in that the dryer is dimensioned to be so efficient that the dry matter content of the coating after the dryer is over 85%.

5. A method as claimed in any of the claims above, characterised in that the dryer is dimensioned so that the travel time of the paper web in the area of the said dryer is less than 500 ms, preferably less than 300 ms.

6. A method as claimed in any of the claims above, characterised in that at least one turning roll or the like is placed between the dryer units that are placed close to each other, in the case that the dryer units are not parallel as regards the paper web direction.

7. A method as claimed in any of the claims above, characterised in that the paper is coated with one or two coating layers either on one side or on two sides.

8. A method as claimed in any of the claims above, characterised in that the paper is dried further after the dryer with a cylinder group, or the web's travel is assisted with a drawing roll group and at the end reeled up with a roller.

9. An arrangement in the manufacture of coated printing paper based on doctor blade coating technique, the paper web being coated at least on one side, whereby the paper web is provided after the coating station with a dryer for drying the paper, by means of which dryer the web is dried with hot air or superheated steam or infrared radiation, or a combination of these is used, characterised in that the said dryer is placed immediately after the coating station and that the drying of the paper takes place in the said dryer at least until the coating in the dryer area reaches its solidification point and the dry matter content of the coating after the dryer is at least 73%.

10. An arrangement as claimed in claim 9, characterised in that the dryer is either one single dryer or several dryer units placed close to each other.

11. An arrangement as claimed in claim 10, characterised in that the forward end of the dryer is at a distance of less than 4 meters from the coating station, but preferably at a distance of less than 2 meters from the coating station.

12. An arrangement as claimed in any of the claims 9-11 above, characterised in that the dryer is so efficient that the dry matter content of the coating after the dryer is over 85%.

13. An arrangement claimed in any of the claims 9-12 above, characterised in that the travel time of the paper web in the area of the dryer is less than 500 ms, preferably less than 300 ms.

14. An arrangement as claimed in any of the claims 9-13 above, characterised in that there is at least one turning roll or the like between the dryer units which are placed close to each other, in the case that the dryer units are not parallel as regards the paper web direction.

15. An arrangement as claimed in claim 14, characterised in that there is at least one coating station, but preferably there are two paper coating layers either on one side or on two sides.

16. An arrangement as claimed in any of the claims 9-15 above, characterised in that there is a further cylinder group after the dryer for drying the paper, or there is a drawing roll group for assisting the web's travel and a roller for reeling up the paper.
